(19) United States
(12) Patent Application Publication
(10) Pub. No.: US 2012/0113629 A1
(43) Pub. Date: May 10, 2012

(54) Outdoor solar Tiki floor lamp

(76) Inventor: Diane Michelle Steele, Gaithersburg, MD (US)

(21) Appl. No.: 13/200,047

(22) Filed: Sep. 17, 2011

Related U.S. Application Data
(60) Provisional application No. 61/384,048, filed on Sep. 17, 2010.

(51) Int. Cl. F21L 4/00

(52) U.S. Cl. 362/190

(57) ABSTRACT

The claim for this invention is: 1) a solar powered outdoor garden floor lamp comprising: a) a weather resistant, rigid outdoor floor lamp base associated with b) an operable weather resistant, rigid outdoor solar garden lamp and lamp pole, such that the outdoor solar floor lamp in its entirety may be functional and rest firmly and safely on flat hard or soft surfaces because of the addition of the floor lamp base. This invention increases the usefulness for outdoor solar garden lamps. The additional uses for this solar lamp would include but not be limited to patios, underneath gazebos, decks, balconies, poolside, porches, docks and piers, or any hard surface, and also still includes traditional garden edges, lawns and other flat but soft surfaces. In addition, this outdoor solar floor lamp may be used indoors, after being charged using sunlight, in areas that lack electricity or where electricity is unaffordable.

### BACKGROUND OF THE INVENTION

This invention relates generally to outdoor solar powered garden lamps (Des. 316,458) that commonly used in residential backyards and commonly using surface-piercing (e.g., typically soil-piercing) instrumentation as the means of lamp support (U.S. Pat. No. D464,156 S). A disadvantage of the surface-piercing solar lamps for support is that they can only be placed on penetrable surfaces which limits the areas in which they can be used to places with soft or penetrable surfaces. The current invention solves this problem by substituting the surface-piercing base with an outdoor floor lamp base which then enables the solar powered garden lamp to be used on both hard and soft surfaces. This improvement expands their utility.

### PRIOR ART

A wide variety of outdoor solar powered garden lamps are either patented or on the market without patent but none appear to exist that specifically include the outdoor floor lamp base that is the sole claim this invention. The patents identified as related to the invention during a patent search include:

### Solar Lighting for Garden or Driveway

Pat. No.: 4,835,664

Date of Patent: May 30, 1989

Solar Powered Outdoor Recreational Light with Positionable Solar Panel

Pat. No: 4,977,488

Date of Patent: Dec. 11, 1990

### Solar Powered Outdoor Recreational Lamp

Pat. No.: Des. 316,458

Date of Patent: Apr. 23, 1991

### Pagoda Copper Torch Design

Pat. No.: U.S. Pat. No. D450,140 S

Date of Patent: Nov. 6, 2001

### Tiki Torch

Pat. No.: U.S. Pat. No. D456,917 S

Date of Patent: May 7, 2002

### Torch

Pat. No.: U.S. Pat. No. D464,156 S

Date of Patent: Oct. 8, 2002

### BRIEF SUMMARY OF THE INVENTION

The current invention uses any rigid non-corrosive outdoor floor lamp base in combination with an outdoor solar garden lamp to allow the lamp to rest firmly, steadily, and safely on any flat surface, hard or soft. This application improves upon current outdoor solar garden lights with surface-penetrating (spike) bases which are useful only on soft penetrable surfaces. The specific style of the outdoor floor lamp base is not of importance to the current invention and may be any design, solid or otherwise, as long as it is heavy and wide enough to support the lamp in a horizontal gravity-centered position in a variety of weather conditions (e.g., wind, rain). The unique application of the outdoor floor lamp base to the outdoor solar garden lamp allows these lamps to be used in a wider variety of locations than those that use the soft surface-piercing method. The new uses for this solar lamp would include but not be limited to apartment and other balconies, patios, underneath gazebos, decks, piers, concrete pool sides, etc., and yet also still includes use on traditional garden edges, lawns and other flat but soft surfaces. This invention allows for such solar lamps to be used effectively indoors as well, for example during power outage circumstances or where electricity is unavailable or unaffordable. This invention increases the utility areas for outdoor solar lamps.

### BRIEF DESCRIPTION OF THE DRAWINGS

FIG. 1 is a Block Diagram of the invention shows in simple terms the general components that illustrate the general concept of the invention and some possible design features. The diagram shows that solar energy is collected from the sun and may be stored by some means in the lamp top (1). Lamp bulbs are electrically powered using the collected solar energy (2). The top (1), power storage, lamp bulbs, lamp globe, decorative globe housing (2), are attached to a lamp pole (3)(4)(5)(6). The lamp pole may be comprised of several segments that are joined by any method (e.g., screw-in, fit-in, or some other joining method) (3)(4)(5)(6), or may be one piece. The pole-to-base joining area is the area in which the bottom-most segment of the lamp pole attaches to a base in some secure manner that will enable the lamp pole to fit upright and be gravitationally centered on the heavy base (7). The base (8) may have a decorative cover (9) or be any style, and it may have footers to aid in the flow of water underneath the base (10).

FIG. 2 shows a general schematic of the Outdoor Solar Tiki Floor Lamp—a combination of the outdoor floor lamp base and the outdoor solar garden lamp. The labels are the same as in FIG. 1 described above, without item (9).

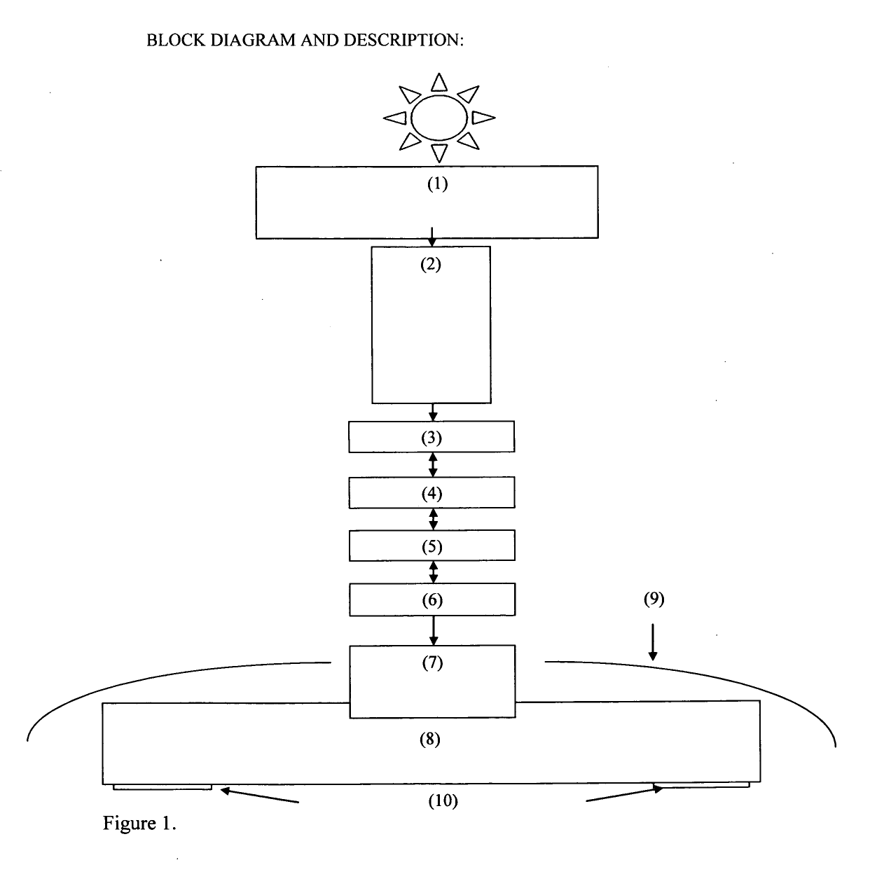

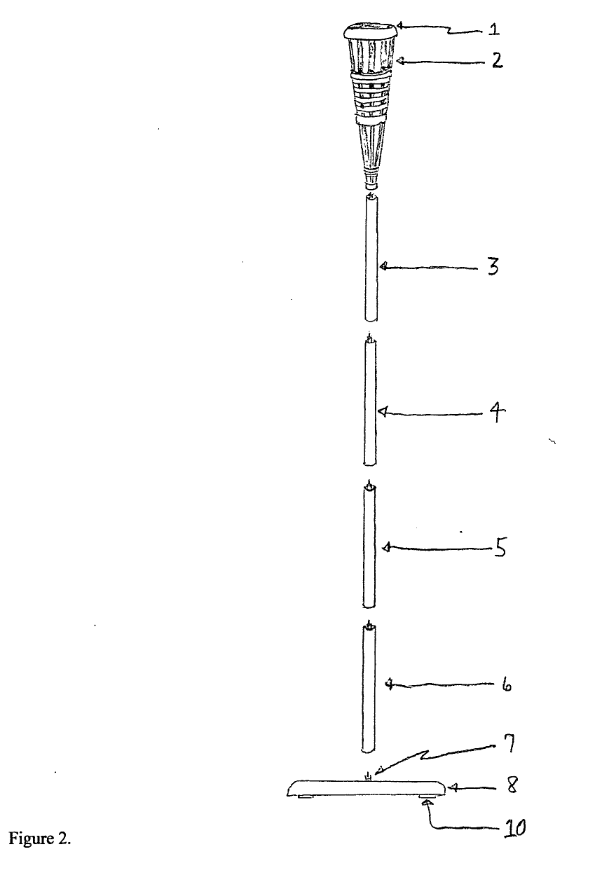

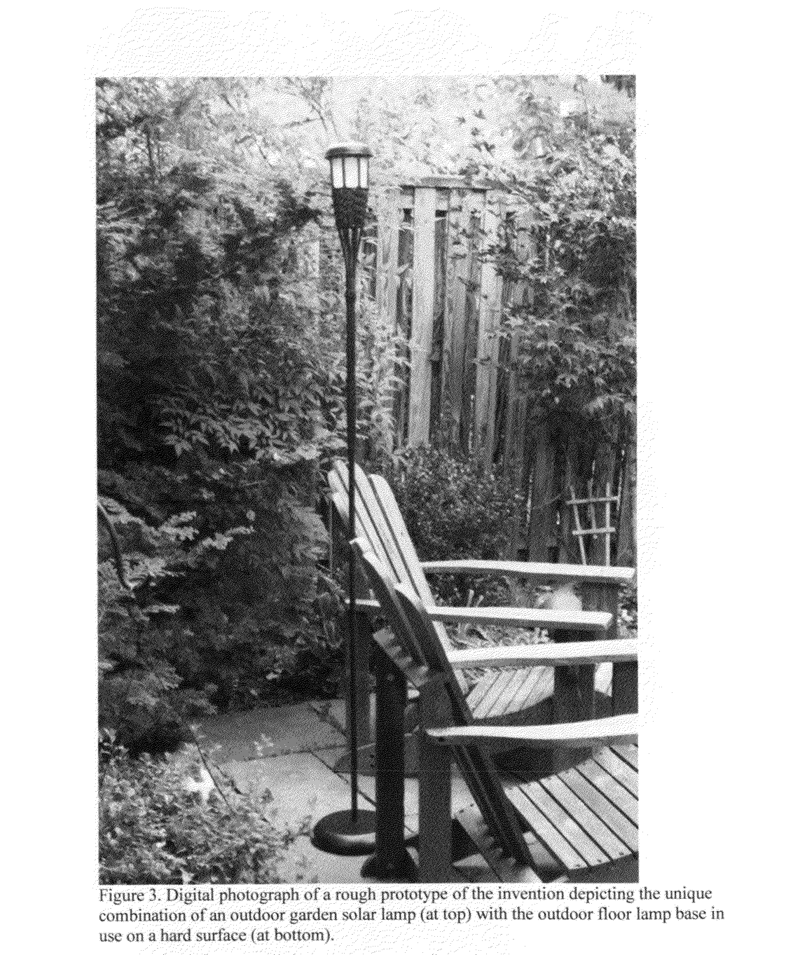

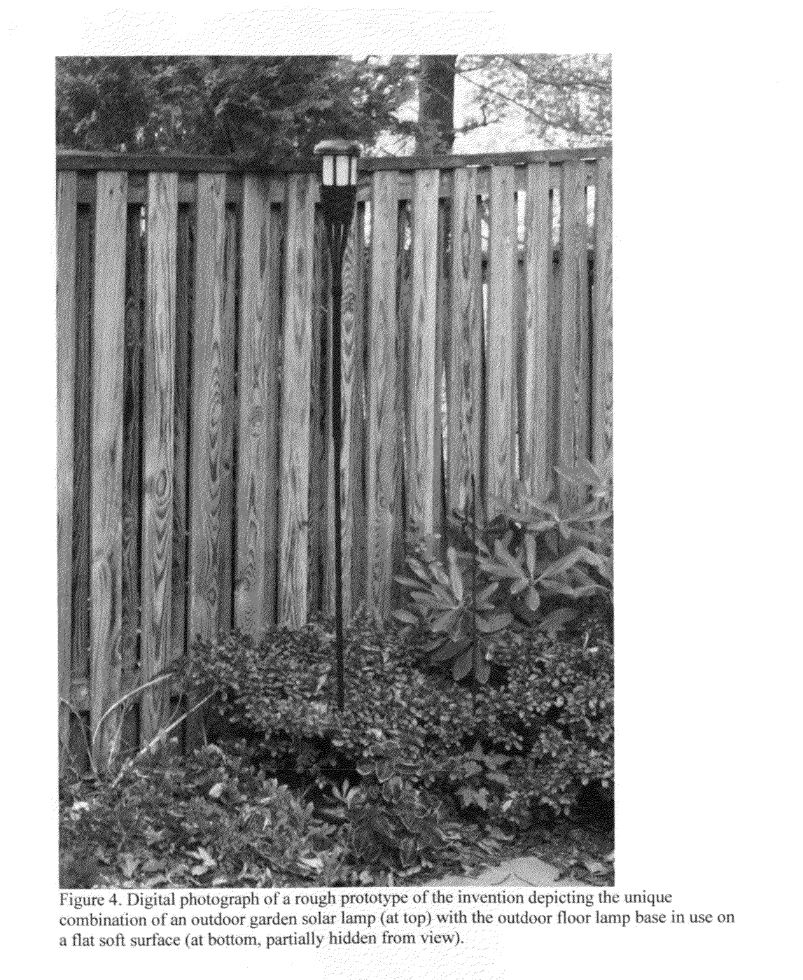

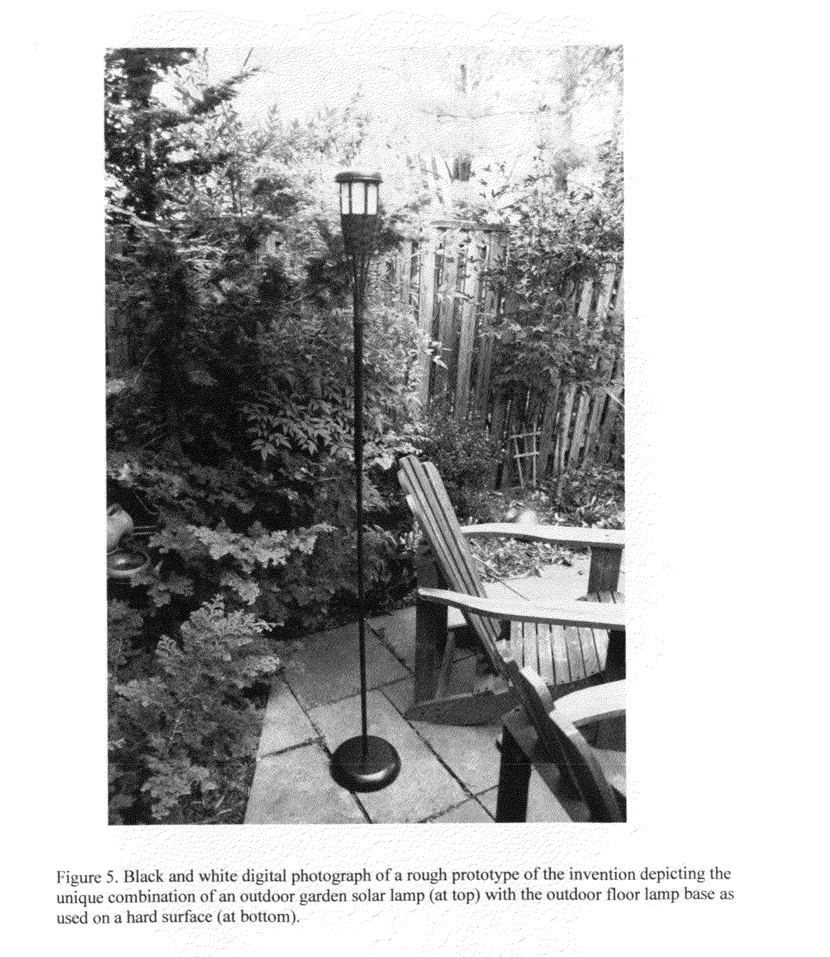

The above descriptions in FIGS. 1 and 2 of the prototype of the invention are not meant to limit the design concepts in any way but instead are intended simply to illustrate the outdoor floor lamp base in use with the solar garden lamp and the utility of the improvement.

### DETAILED DESCRIPTION OF THE INVENTION

The current invention uses any rigid non-corrosive outdoor floor lamp base in combination with an outdoor solar garden lamp to allow the lamp to rest firmly, steadily, and safely on any flat surface, hard or soft. The outdoor floor lamp base is heavy enough to maintain an upright and gravitationally centered balance for the outdoor solar lamp. The base may be made of one or more materials such as metals, plastics, or other materials that are rigid and non-corrosive. The base may have a decorative housing of any material or be decorative in itself (for example, it could have any heavy outdoor floor lamp base design.). The base may have ridges on the underside to provide space for water flow, or be any other preferred design as long as it holds the solar lamp firmly and safely upright.

Joined to the outdoor floor lamp base is a lamp pole that may screw into the base or otherwise fit precisely into the base so as to allow for vertical gravitational balance. The lamp pole may include pole segments that may fit into one another in a screw-in or fit-in manner or any sturdy manner so that the lamp will maintain a steady vertical balance. The pole is required but may be of any design.

On top of the lamp pole is a required solar lamp with any style decorative housing and globe design. The solar lamp housing is required and may be joined to the topmost pole segment in the same manner as the pole segments are connected, fitted or screw-on. A solar energy collecting panel or apparatus is required and may be located at the top of the lamp cap such that the rays of the sun may shine on to it. The solar powered lightbulb(s) are required and automatically turn on when it becomes dark outside and may be amber (or other color), flickering (or steady) light emitting diode type light. A means of storing the solar energy, such as with batteries, is required. All apparatus necessary to power (collect, store, and use) the solar light are required.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the basic principles of the present invention and its practical application, to thereby enable others skilled in the art to best utilize the present invention and various embodiments with various modifications as are suited to the particular use contemplated.

1. The claim for this invention is: 1) a solar powered outdoor garden floor lamp comprising: a) a weather resistant, rigid outdoor floor lamp base associated with b) an operable weather resistant, rigid outdoor solar garden lamp and lamp pole, such that the outdoor solar floor lamp in its entirety may be functional and rest firmly and safely on flat hard or soft surfaces because of the addition of the floor lamp base. This invention increases the usefulness for outdoor solar garden lamps.
